(19) United States
(12) Patent Application Publication
(10) Pub. No.: US 2008/0153522 A1
(43) Pub. Date: Jun. 26, 2008

(54) Message transaction method and mobile communication devices to implement the same

(75) Inventors: Poh-Sien Liu, Neihu (TW); Wen-Hung Chung, Neihu (TW)

Correspondence Address: ROSENBERG, KLEIN & LEE, 3458 ELLICOTT CENTER DRIVE-SUITE 101, ELLICOTT CITY, MD, 21043, US

(73) Assignee: Lite-On Technology Corp.

(21) Appl. No.: 11/802,193

(22) Filed: May 21, 2007

(30) Foreign Application Priority Data
Dec. 26, 2006 (TW) 09514952

(51) Int. Cl. H04Q 7/20

(52) U.S. Cl. 455/466

(57) ABSTRACT

A message transaction method includes the steps of sending a connection request, receiving the connection request, generating a ringing response signal in response to the connection request, counting an elapsed time starting from generation of the ringing response signal, sending a disconnection request, stopping of the counting of the elapsed time upon detection of the disconnection request, comparing the elapsed time with at least one relation mapped by a lookup table, and providing a corresponding message in the matching relation. A system to implement the message transaction method is also disclosed.

### CROSS-REFERENCE TO RELATED APPLICATION

This application claims priority of Taiwanese Application No. 095148952, filed on Dec. 26, 2006.

### BACKGROUND OF THE INVENTION

1. Field of the Invention

The invention relates to a message transaction method for sending messages between mobile communication devices, more particularly to a message transaction method for sending messages between mobile communication devices that translates duration of a ringing signal into a corresponding message.

2. Description of the Related Art

Mobile phones are widely used for many years as a tool for voice communications. The subscriber is normally charged based on the length of time of an outgoing voice call.

Over the recent years, short message service, which permits sending of short messages between mobile phones, has become increasingly popular as an alternative to the voice call. The subscriber is charged based on the number of the short messages sent, which is comparatively inexpensive.

It is desirable to provide a message transaction method that permits sending of messages between mobile phones free of charge.

### SUMMARY OF THE INVENTION

According to a first aspect of the present invention, a message transaction method comprises the steps of:

A) enabling a receiving mobile communication device to receive a connection request from a sending mobile communication device;

B) enabling the receiving mobile communication device to generate a ringing response signal to be sent to the sending mobile communication device in response to the connection request;

C) enabling the receiving mobile communication device to count an elapsed time starting from generation of the ringing response signal;

D) enabling the receiving mobile communication device to detect receipt of a disconnection request from the sending mobile communication device;

E) enabling the receiving mobile communication device to stop counting the elapsed time upon detection of the disconnection request;

F) enabling the receiving mobile communication device to compare the elapsed time counted thereby with a lookup table established in the receiving mobile communication device, wherein the lookup table maps at least one relation between a ringing response signal interval and a corresponding message; and

G) if the receiving mobile communication device finds a matching relation in the lookup table, enabling the receiving mobile communication device to provide the corresponding message of the matching relation to the user of the receiving mobile communication device.

According to a second aspect of the present invention, a message transaction method comprises the steps of:

a) configuring a sending mobile communication device with a lookup table that maps at least one relation between a ringing response signal interval and a corresponding message;

b) enabling operation of the sending mobile communication device to select a desired relation in the lookup table;

c) enabling the sending mobile communication device to send a connection request to a receiving mobile communication device;

d) enabling the sending mobile communication device to receive a ringing response signal from the receiving mobile communication device;

e) enabling the sending mobile communication device to count an elapsed time starting from receipt of the ringing response signal; and

f) enabling the sending mobile communication device to send a disconnection request to the receiving mobile communication device when the elapsed time counted by the sending mobile communication device corresponds to the ringing response signal interval in the desired relation selected in step b).

According to a third aspect of the present invention, a receiving mobile communication device comprises a control module, a communication module, a timer, a memory module, and a message output unit. The communication module is coupled to and controlled by the control module, and is operable so as to generate a ringing response signal to be sent to a sending mobile communication device in response to a connection request received from the sending mobile communication device. The timer is coupled to and controlled by the control module, and is operable so as to count an elapsed time starting from generation of the ringing response signal, and so as to stop counting the elapsed time in response to a disconnection request received from the sending mobile communication device. The memory module is coupled to the control module for storing a lookup table that maps at least one relation between a ringing response signal interval and a corresponding message. The message output unit is coupled to the control module. Upon detection of receipt of the disconnection request, the control module is configured so as to compare the elapsed time counted by the timer with the lookup table, and so as to control the message output unit to provide the corresponding message of the matching relation to the user of the receiving mobile communication device if the control module finds a matching relation in the lookup table.

According to a fourth aspect of the present invention, a system comprises a sending mobile communication device that includes a control module, a memory module, an input module, a communication module, and a timer. The memory module is coupled to the control module for storing a lookup table that maps at least one relation between a ringing response signal interval and a corresponding message. The input module is coupled to the control module, and is operable so as to generate a control signal for enabling selection of a relation in the lookup table by the control module. The communication module is coupled to and controlled by the control module, and is operable so as to send a connection request and so as to receive subsequently a ringing response signal. The timer is coupled to and controlled by the control module, and is operable so as to count an elapsed time starting from receipt of the ringing response signal. The communication module is further operable so as to send a disconnection request when the elapsed time counted by the timer corresponds to the ringing response signal interval in the selected relation.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a system according to the present invention; and

FIGS. 2A to 2F are flow charts of the preferred embodiment of a message transaction method to be implemented using the system shown in FIG. 1 according to the present invention.

### DETAILED DESCRIPTION OF THE PREFERRED EMBODIMENT

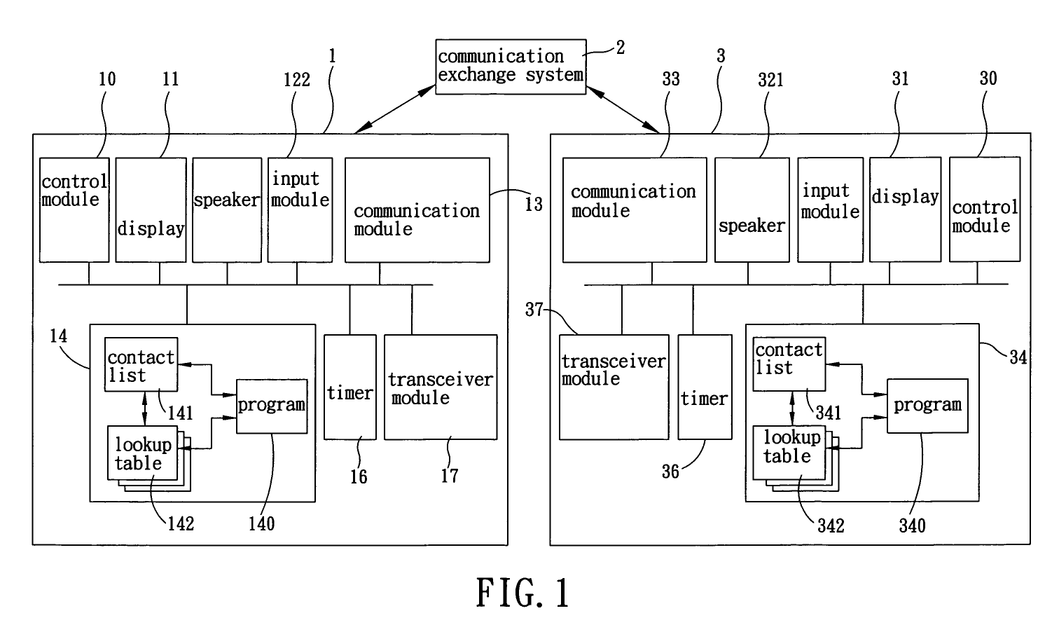

Referring to FIG. 1, the preferred embodiment of a system for implementing a message transaction method according to this invention includes sending and receiving mobile communication devices 1, 3.

The sending and receiving mobile communication devices 1, 3 establish a connection therebetween through a conventional communication exchange system 2. The communication exchange system 2 allocates an appropriate channel for establishing the connection between the sending and receiving mobile communication devices 1, 3, and handles transmission of communication signals between the sending and receiving mobile communication devices 1, 3.

The sending mobile communication device 1 includes a control module 10, a memory module 14, an input module 122, a communication module 13, and a timer 16.

The memory module 14 is connected electrically to the control module 10, and stores a program 140 to be executed by the control module 10 for performing steps associated with the message transaction method, in a manner that will be described hereinafter.

The sending mobile communication device 1 is configured with a lookup table 142 that is stored in the memory module 14 thereof. In this embodiment, the lookup table 142, as shown in Table I, maps a set of relations between ringing response signal intervals and corresponding messages.

TABLE I
Identification code of the sending mobile communication
device 1

| | | | |
|---|---|---|---|
| ringing | 1 second | Message | Please call back |
| response | 2 seconds | | I'll call you later |
| signal | 3 seconds | | I'll be late |
| interval | 4 seconds | | Thank you |
| | 5 seconds | | Sorry |
| | 6 seconds | | Good luck |

The memory module 14 further stores a contact list 141 that maps a relation between the name of the user of the receiving mobile communication device 3 and a corresponding identification code of the receiving mobile communication device 3, such as a phone number.

It is noted that the lookup table 142 configured in the sending mobile communication device 1 includes the identification code of the receiving mobile communication device 3 so that the lookup table 142 can correspond with the receiving mobile communication device 3.

The input module 122 is connected electrically to the control module 10, and is operable so as to generate control signals, such as for enabling selection of a desired one of the relations in the lookup table 142 by the control module 10. In this embodiment, the input module 122 may be a touchpad or a keypad.

The communication module 13 is connected electrically to and controlled by the control module 10, and is operable so as to send a connection request and so as to subsequently receive a ringing response signal.

The timer 16 is connected electrically to and controlled by the control module 10, and is operable so as to count an elapsed time starting from receipt of the ringing response signal.

The communication module 13 is further operable so as to send a disconnection request when the elapsed time counted by the timer 16 corresponds to the ringing response signal interval in the desired relation selected by the control module 10.

The sending mobile communication device 1 further includes a display 11 that is connected electrically to and controlled by the control module 10, and that is operable so as to show a main menu and submenus for selection by the user of the sending mobile communication device 1.

The sending mobile communication device 1 further includes a transceiver module 17 that is connected electrically to and controlled by the control module 10, and that is operable so as to transmit the lookup table 142. In this embodiment, the transceiver module 17 is a wireless transceiver module that complies with a Bluetooth or an infrared data association (IrDA) specification. In an alternative embodiment, the transceiver module 17 is a wired transceiver module.

The receiving mobile communication device 3 includes a control module 30, a memory module 34, a communication module 33, and a timer 36.

The memory module 34 is connected electrically to the control module 30, and stores a program 340 to be executed by the control module 30 for performing steps associated with the message transaction method, in a manner that will be described hereinafter.

The receiving mobile communication device 3 is established with a lookup table 342 that is stored in the memory module 34 thereof and that is identical to that of the sending mobile communication device 1.

The memory module 34 further stores a contact list 341 that maps a relation between the name of the user of the sending mobile communication device 1 and a corresponding identification code of the sending mobile communication device 1, such as a phone number.

It is noted that the lookup table 342 established in the receiving mobile communication device 3, as shown in Table II, includes the identification code of the sending mobile communication device 1 so that the lookup table 342 can correspond with the sending mobile communication device 1.

TABLE II
Identification code of the receiving mobile communication
device 3

| | | | |
|---|---|---|---|
| ringing | 1 second | Message | Please call back |
| response | 2 seconds | | I'll call you later |
| signal | 3 seconds | | I'll be late |
| interval | 4 seconds | | Thank you |
| | 5 seconds | | Sorry |
| | 6 seconds | | Good luck |

The communication module 33 is connected electrically to and controlled by the control module 30, and is operable so as to receive the connection request from the communication module 13 of the sending mobile communication device 1, so as to generate the ringing response signal to be sent to the sending mobile communication device 1 in response to the connection request, and so as to detect the disconnection request from the communication module 13 of the sending mobile communication device 1.

The timer 36 is connected electrically to and controlled by the control module 30, and is operable so as to count an elapsed time starting from generation of the ringing response signal, and so as to stop counting the elapsed time in response to the disconnection request.

Upon detection of receipt of the disconnection request, the control module 30 is configured so as to compare the elapsed time counted by the timer 36 with the lookup table 342 established in the receiving mobile communication device 3.

The receiving mobile communication device 3 further includes a message output unit in the form of a display 31 that is connected electrically to and controlled by the control module 30 of the receiving mobile communication device 3 so as to provide the corresponding message of a matching relation to the user of the receiving mobile communication device 3 via a text output if the control module 30 finds the matching relation in the lookup table 342.

The receiving mobile communication device 3 further includes a speaker 321 that is connected electrically to and controlled by the control module 30, and that is operable so as to produce an audible call alert.

The control module 30 is further operable so as to compare an identification code of the sending mobile communication device 1 in the connection request with the contact list 341. When a matching identification code is found in the contact list 341, the control module 30 disables operation of the speaker 321 of the receiving mobile communication device 3. On the other hand, when the matching identification code is not found in the contact list 341, the control module 30 processes the connection request as an incoming voice call and controls the speaker 321 to produce the audible call alert. In this case, the control module 30 does not compare the elapsed time counted by the timer 36 with the lookup table 342.

The control module 30 is further operable so as to determine if the elapsed time counted by the timer 36 has reached a predetermined threshold. If the predetermined threshold has not yet been reached, the timer 36 continues the counting of the elapsed time. On the other hand, if the predetermined threshold was reached, the control module 30 processes the connection request as an incoming voice call. In this case, the control module 30 does not compare the elapsed time counted by the timer 36 with the lookup table 342.

The receiving mobile communication device 3 further includes a transceiver module 37 that is connected electrically to and controlled by the control module 30, and that is operable so as to receive the lookup table 142 from the transceiver module 17 of the sending mobile communication device 1, thereby establishing the lookup table 342 in the receiving mobile communication device 3. In this embodiment, the transceiver module 37 is a wireless transceiver module that complies with a Bluetooth or an infrared data association (IrDA) specification. In an alternative embodiment, the transceiver module 37 is a wired transceiver module.

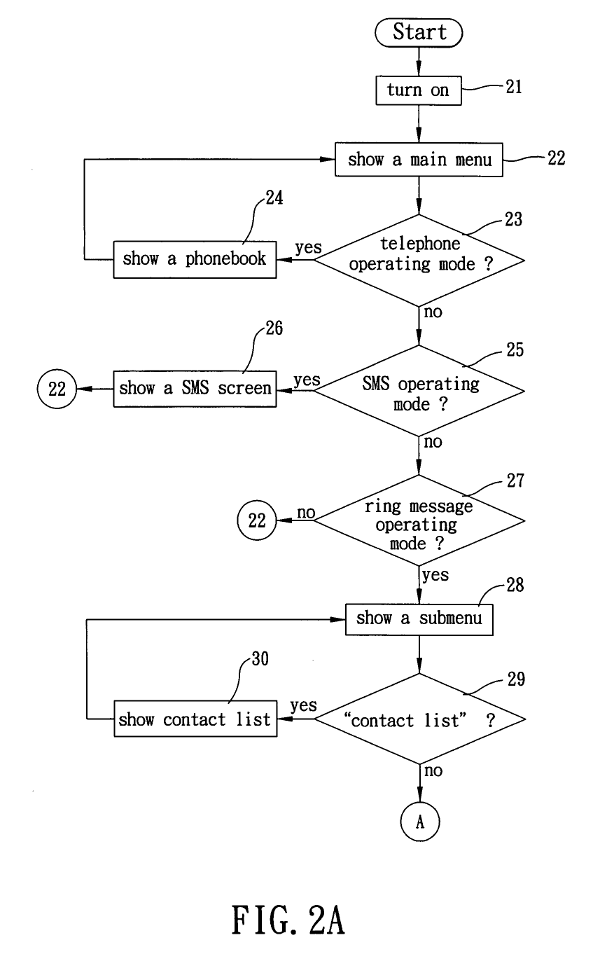

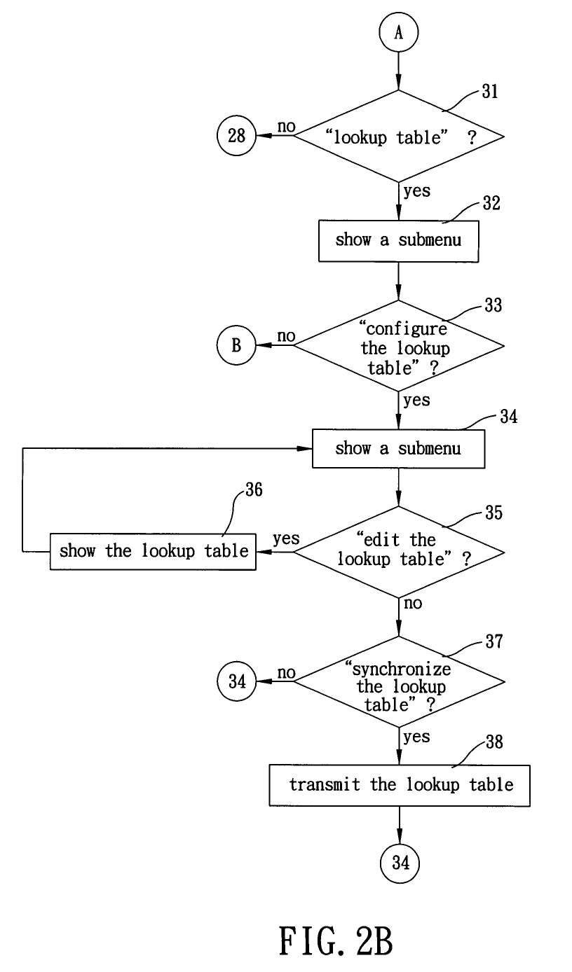

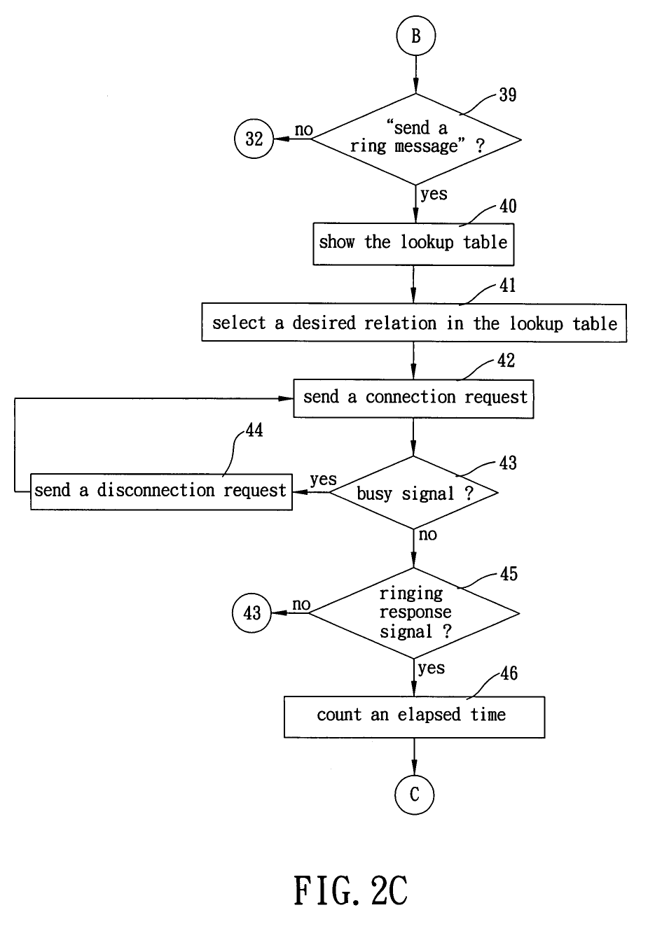

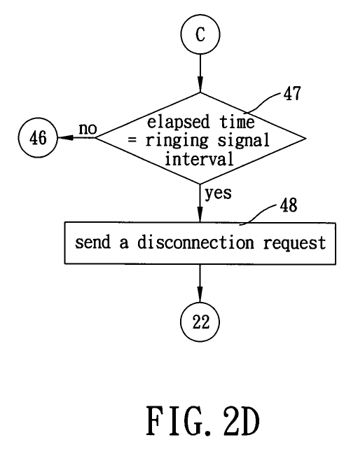

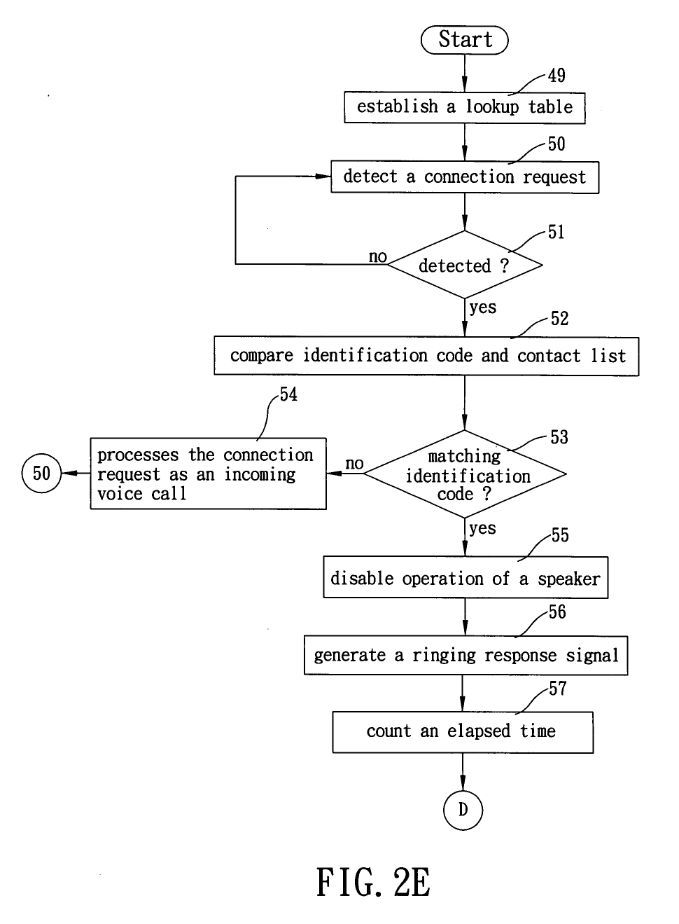

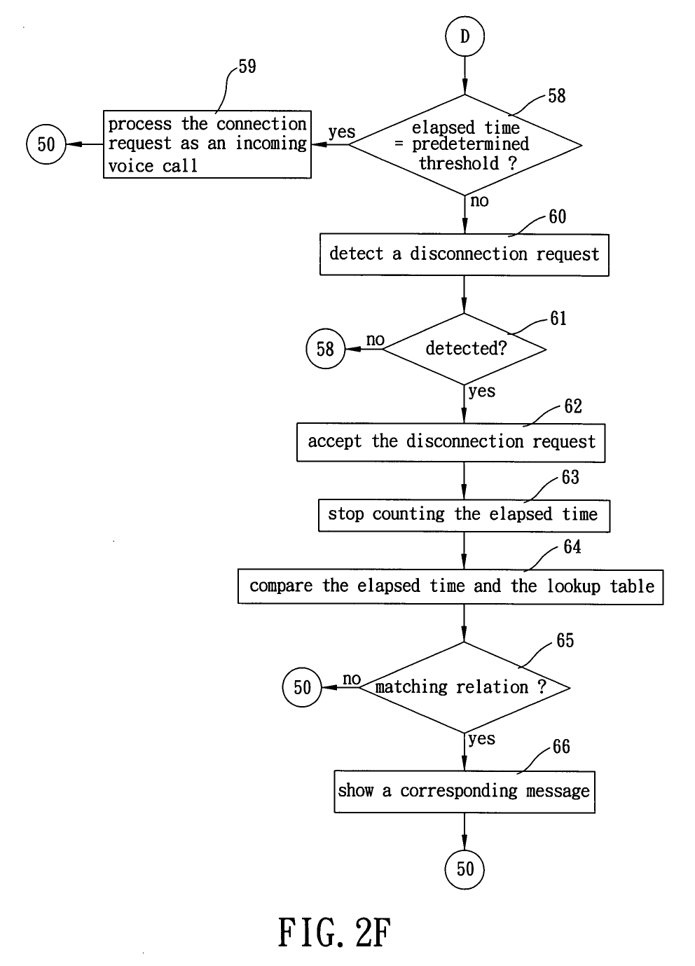

The preferred embodiment of the message transaction method to be implemented using the aforementioned system according to this invention includes the steps, which are performed by the sending mobile communication device 1, shown in FIGS. 2A to 2D.

In step 21, the sending mobile communication device 1 is turned on.

In step 22, the display 11 shows a main menu that allows selection of different operating modes of the sending mobile communication device 1.

In step 23, if the input module 122 is operated to generate a control signal such that a telephone operating mode is selected, the flow proceeds to step 24. Otherwise, the flow proceeds to step 25.

In step 24, the display 11 shows a phonebook. At this time, the user of the sending mobile communication device 1 may proceed to make an outgoing voice call using the phonebook in a conventional manner. Thereafter, the flow goes back to step 22.

In step 25, if the input module 122 is operated to generate a control signal such that a short message service (SMS) operating mode is selected, the flow proceeds to step 26. Otherwise, the flow proceeds to step 27.

In step 26, the display 11 shows a SMS screen for entering a short message. At this time, the user may proceed to create and send a short message using the phonebook in a conventional manner. Thereafter, the flow goes back to step 22.

In step 27, if the input module 122 is operated to generate a control signal such that a ring message operating mode is selected, the flow proceeds to step 28. Otherwise, the flow goes back to step 22.

In step 28, the display 11 shows a submenu that allows selection between a “contact list” and a “lookup table”.

In step 29, if the input module 122 is operated to generate a control signal such that the “contact list” is selected, the flow proceeds to step 30. Otherwise, the flow proceeds to step 31.

In step 30, the display 11 shows the contact list 141 stored in the memory module 14. At this time, the user of the sending mobile communication device 1 may proceed to add, edit, or delete a relation from the contact list 141. Thereafter, the flow goes back to step 28.

In step 31, if the input module 122 is operated to generate a control signal such that the “lookup table” is selected, the flow proceeds to step 32. Otherwise, the flow goes back to step 28.

In step 32, the display 11 shows a submenu that allows selection between “configure the lookup table” and “send a ring message”.

In step 33, if the input module 122 is operated to generate a control signal such that the “configure the lookup table” option is selected, the flow proceeds to step 34. Otherwise, the flow proceeds to step 39.

In step 34, the display module 11 shows a submenu that allows selection between “edit the lookup table” and “synchronize the lookup table”.

In step 35, if the input module 122 is operated to generate a control signal such that the “edit the lookup table” option is selected, the flow proceeds to step 36. Otherwise, the flow proceeds to step 37.

In step 36, the display 11 shows the lookup table 142 stored in the memory module 14. At this time, the user of the sending mobile communication device 1 may proceed to edit and save the lookup table 142. Thereafter, the flow goes back to step 34.

In step 37, if the input module 122 is operated to generate a control signal such that the “synchronize the lookup table” option is selected, the flow proceeds to step 38. Otherwise, the flow goes back to step 34.

In step 38, the transceiver module 17 of the sending mobile communication device transmits the lookup table 142 to the receiving mobile communication device 3. Thereafter, the flow goes back to step 34.

In step 39, if the input module 122 is operated to generate a control signal such that the “send a ring message” option is selected, the flow proceeds to step 40. Otherwise, the flow goes back to step 32.

In step 40, the display 11 shows the lookup table 142.

In step 41, the input module 122 is operated to generate a control signal to enable selection of a desired relation in the lookup table 142 by the control module 10.

In step 42, the communication module 13 sends a connection request to the receiving mobile communication device 3.

In step 43, if the communication module 13 receives a busy signal from the receiving mobile communication device 3, the flow proceeds to step 44. Otherwise, the flow proceeds to step 45.

In step 44, the communication module 13 sends a disconnection request to the receiving mobile communication device 3. Thereafter, the flow goes back to step 40.

In step 45, if the communication module 13 receives a ringing response signal from the receiving mobile communication device 3, the flow proceeds to step 46. Otherwise, the flow goes back to step 43.

In step 46, the timer 16 counts an elapsed time starting from the receipt of the ringing response signal.

In step 47, when the elapsed time counted by the timer 16 corresponds to the ringing signal interval in the desired relation selected in step 41, the flow proceeds to step 48. Otherwise, the flow goes back to step 46.

In step 48, the communication module 13 sends a disconnection request to the receiving mobile communication device 3. Thereafter, the flow goes back to step 22.

The preferred embodiment of the message transaction method further includes the steps, which are performed by the receiving mobile communication device 3, shown in FIGS. 2E and 2F.

In step 49, the lookup table 342 is established in the receiving mobile communication device 3. That is, the transceiver module 37 receives the lookup table 142 transmitted in step 38.

In step 50, the communication device 33 detects receipt of the connection request from the sending mobile communication device 1.

In step 51, if the communication device 33 detects the connection request, the flow proceeds to step 52. Otherwise, the flow goes back to step 50.

In step 52, the control module 30 compares the identification code of the sending mobile communication device 1 in the connection request with the contact list 341.

In step 53, when the control module 30 finds a matching identification code in the contact list 341, the flow proceeds to step 55. Otherwise, the flow proceeds to step 54.

In step 54, the control module 30 processes the connection request as an incoming voice call in a conventional manner. Thereafter, the flow goes back to step 50.

In step 55, the control module 30 disables operation of the speaker 321. That is, the receiving mobile communication device 3 operates in a silent mode.

In step 56, the communication module 33 generates the ringing response signal to be sent to the sending mobile communication device 1 in response to the connection request.

In step 57, the timer 36 counts an elapsed time starting from generation of the ringing response signal.

In step 58, if the control module 30 determines that the elapsed time counted by the timer 36 has reached a predetermined threshold, the flow proceeds to step 59. Otherwise, the flow proceeds to step 60.

In step 59, the control module 30 processes the connection request as an incoming voice call. Thereafter, the flow goes back to step 50.

In step 60, the communication module 33 detects receipt of a disconnection request from the sending mobile communication device 1.

In step 61, upon detection of the disconnection request, the flow proceeds to step 62. Otherwise, the flow goes back to step 58.

In step 62, the control module 30 accepts the disconnection request.

In step 63, the timer 36 stops counting the elapsed time.

In step 64, the control module 30 compares the elapsed time counted by the timer 36 with the lookup table 342 in the memory module 34.

In step 65, if the control module 30 finds a matching relation in the lookup table 342, the flow proceeds to step 66. Otherwise, the flow goes back to step 50.

In step 66, the display 31 shows the corresponding message of the matching relation found in step 65 to the user of the receiving mobile communication device 3. Thereafter, the flow goes back to step 50.

It should be noted herein that the corresponding messages in the lookup table 342 are not limited to text form and may be audio files so that messages are provided to the user of the receiving mobile communication device 3 via an audio output in other embodiment of this invention.

From the above description, the message transaction method of this invention translates different intervals of ringing signals into messages using a lookup table. As such, the messages can be sent from the sending mobile communication device 1 to the receiving mobile communication device 3 without incurring any costs on the subscriber of the sending mobile communication device 1. Furthermore, the message transaction method of this invention is implemented as a program that is installed in the sending and receiving mobile communication devices 1, 3, and requires no additional hardware to be installed in the sending and receiving mobile communication devices 1, 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A message transaction method, comprising:
A) enabling a receiving mobile communication device to receive a connection request from a sending mobile communication device;
B) enabling the receiving mobile communication device to generate a ringing response signal to be sent to the sending mobile communication device in response to the connection request;
C) enabling the receiving mobile communication device to count an elapsed time starting from generation of the ringing response signal;
D) enabling the receiving mobile communication device to detect receipt of a disconnection request from the sending mobile communication device;
E) enabling the receiving mobile communication device to stop counting the elapsed time upon detection of the disconnection request;
F) enabling the receiving mobile communication device to compare the elapsed time counted thereby with a lookup table established in the receiving mobile communication device, wherein the lookup table maps at least one relation between a ringing response signal interval and a corresponding message; and
G) if the receiving mobile communication device finds a matching relation in the lookup table, enabling the receiving mobile communication device to provide the corresponding message of the matching relation to the user of the receiving mobile communication device.

2. The message transaction method as claimed in claim 1, further comprising, prior to step B):
H) enabling the receiving mobile communication device to compare an identification code of the sending mobile communication device in the connection request with a contact list configured in the receiving mobile communication device;
I) enabling the receiving mobile communication device to operate in a silent mode when a matching identification code is found in the contact list; and
J) enabling operation of the receiving mobile communication to process the connection request as an incoming voice call and to not perform step F) when the matching identification code is not found in the contact list.

3. The message transaction method as claimed in claim 1, wherein step C) includes enabling the receiving mobile communication device to determine if the elapsed time counted thereby has reached a predetermined threshold, wherein counting of the elapsed time is continued if the predetermined threshold has not yet been reached, and wherein the receiving mobile communication device is enabled to process the connection request as an incoming voice call and to not perform step F) if the predetermined threshold was reached.

4. The message transaction method as claimed in claim 1, wherein, in step G), the receiving mobile communication device provides the corresponding message to the user via one of a text output and an audio output.

5. A message transaction method comprising:
a) configuring a sending mobile communication device with a lookup table that maps at least one relation between a ringing response signal interval and a corresponding message;
b) enabling operation of the sending mobile communication device to select a desired relation in the lookup table;
c) enabling the sending mobile communication device to send a connection request to a receiving mobile communication device;
d) enabling the sending mobile communication device to receive a ringing response signal from the receiving mobile communication device;
e) enabling the sending mobile communication device to count an elapsed time starting from receipt of the ringing response signal; and
f) enabling the sending mobile communication device to send a disconnection request to the receiving mobile communication device when the elapsed time counted by the sending mobile communication device corresponds to the ringing response signal interval in the desired relation selected in step b).

6. The message transaction method as claimed in claim 5, further comprising:
i) establishing in the receiving mobile communication device a lookup table identical to that of the sending mobile communication device;
ii) enabling the receiving mobile communication device to receive the connection request from the sending mobile communication device;
iii) enabling the receiving mobile communication device to generate the ringing response signal to be sent to the sending mobile communication device in response to the connection request;
iv) enabling the receiving mobile communication device to count an elapsed time starting from generation of the ringing response signal;
v) enabling the receiving mobile communication device to detect receipt of the disconnection request from the sending mobile communication device;
vi) enabling the receiving mobile communication device to stop counting the elapsed time upon detection of the disconnection request;
vii) enabling the receiving mobile communication device to compare the elapsed time counted thereby with the lookup table established therein; and
viii) if the receiving mobile communication device finds a matching relation in the lookup table, enabling the receiving mobile communication device to provide the corresponding message of the matching relation to the user of the receiving mobile communication device.

7. The message transaction method as claimed in claim 6, wherein, in step i), establishing of the lookup table in the receiving mobile communication device is conducted through transmission of the lookup table configured in the sending mobile communication device.

8. A receiving mobile communication device, comprising:
a control module;
a communication module coupled to and controlled by said control module, and operable so as to generate a ringing response signal to be sent to a sending mobile communication device in response to a connection request received from the sending mobile communication device;
a timer coupled to and controlled by said control module, and operable so as to count an elapsed time starting from generation of the ringing response signal, and so as to stop counting the elapsed time in response to a disconnection request received from the sending mobile communication device;
a memory module coupled to said control module for storing a lookup table that maps at least one relation between a ringing response signal interval and a corresponding message; and
a message output unit coupled to said control module;
wherein, upon detection of receipt of the disconnection request, said control module is configured so as to compare the elapsed time counted by said timer with said lookup table, and so as to control said message output unit to provide the corresponding message of the matching relation to the user of said receiving mobile communication device if said control module finds a matching relation in said lookup table.

9. The receiving mobile communication device as claimed in claim 8, wherein said memory module further stores a contact list, said receiving mobile communication device further comprising a speaker coupled to and controlled by said control module,
said control module being further operable so as to compare an identification code of the sending mobile communication device in the connection request with the contact list, so as to disable operation of said speaker when a matching identification code is found in the contact list, and so as to process the connection request as an incoming voice call in which said speaker is controlled to produce an audible call alert and in which said control module does not compare the elapsed time counted by said timer with said lookup table when the matching identification code is not found in the contact list.

10. The receiving mobile communication device as claimed in claim 8, wherein said control module is further operable so as to determine if the elapsed time counted by said timer has reached a predetermined threshold,
wherein said control module processes the connection request as an incoming voice call and does not compare the elapsed time counted by said timer with said lookup table if the predetermined threshold was reached.

11. The receiving mobile communication device as claimed in claim 8, wherein said message output unit includes a display that is operable so as to provide the corresponding message to the user via a text output.

12. A system, comprising:
a sending mobile communication device including
a control module,
a memory module coupled to said control module for storing a lookup table that maps at least one relation between a ringing response signal interval and a corresponding message,
an input module coupled to said control module, and operable so as to generate a control signal for enabling selection of a relation in the lookup table by said control module,
a communication module coupled to and controlled by said control module, and operable so as to send a connection request and so as to subsequently receive a ringing response signal, and
a timer coupled to and controlled by said control module, and operable so as to count an elapsed time starting from receipt of the ringing response signal,
wherein said communication module is further operable so as to send a disconnection request when the elapsed time counted by said timer corresponds to the ringing response signal interval in the selected relation.

13. The system as claimed in claim 12, further comprising a receiving mobile communication device including
a control module,
a memory module coupled to said control module of said receiving mobile communication device for storing a lookup table identical to that of said sending mobile communication device,
a communication module coupled to and controlled by said control module of said receiving mobile communication device, and operable so as to receive the connection request from said communication module of said sending mobile communication device and so as to generate the ringing response signal to be sent to said sending mobile communication device in response to the connection request,
a timer coupled to and controlled by said control module of said receiving mobile communication device, and operable so as to count an elapsed time starting from generation of the ringing response signal and so as to stop counting the elapsed time in response to the disconnection request received from said communication module of said sending mobile communication device, and
a message output unit coupled to said control module,
said control module of said receiving mobile communication device being configured, upon detection of receipt of the disconnection request, so as to compare the elapsed time counted by said timer of said receiving mobile communication device with said lookup table of said receiving mobile communication device, and so as to control said message output unit to provide the corresponding message of the matching relation to the user of said receiving mobile communication device if said control module of said receiving mobile communication device finds a matching relation in said lookup table of said receiving mobile communication device.

14. The system as claimed in claim 13, wherein said memory module of said receiving mobile communication device further stores a contact list, said receiving mobile communication device further including a speaker that is coupled to and controlled by said control module thereof,
said control module of said receiving mobile communication device being further operable so as to compare an identification code of said sending mobile communication device in the connection request with the contact list, so as to disable operation of said speaker when a matching identification code is found in the contact list, and so as to process the connection request as an incoming voice call in which said speaker is controlled to produce an audible call alert and in which said control module of said receiving mobile communication device does not compare the elapsed time counted by said timer of said receiving mobile communication device with said lookup table of said receiving mobile communication device when the matching identification code is not found in the contact list.

15. The system as claimed in claim 13, wherein said control module of said receiving mobile communication device is further operable so as to determine if the elapsed time counted by said timer of said receiving mobile communication device has reached a predetermined threshold,
wherein said control module of said receiving mobile communication device processes the connection request as an incoming voice call and does not compare the elapsed time counted by said timer of said receiving mobile communication device with said lookup table of said receiving mobile communication device if the predetermined threshold was reached.

16. The system as claimed in claim 13, wherein said lookup table is stored in said memory module of said receiving mobile communication device through transmission of said lookup table stored in said memory module of said sending mobile communication device.

17. The system as claimed in claim 13, wherein said message output unit includes a display that is operable so as to provide the corresponding message to the user of the receiving mobile communication device via a text output.
